(19) United States
(12) Patent Application Publication
(10) Pub. No.: US 2004/0012472 A1
(43) Pub. Date: Jan. 22, 2004

(54) FLUX CONTROL FOR HIGH POWER STATIC ELECTROMAGNETIC DEVICES

(76) Inventors: CHRISTIAN SASSE, VASTERAS (SE); THORSTEN SHUTTE, VASTERAS (SE); MATS LEIJON, VASTERAS (SE); JAN-ANDERS NYGREN, VASTERAS (SE); LARS GERTMAR, VASTERAS (SE); BERTIL BERGGREN, VASTERAS (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 08/980,210

(22) Filed: Nov. 28, 1997

(51) Int. Cl. H01F 27/28

(52) U.S. Cl. 336/180

(57) ABSTRACT

A high power static electromagnetic device with variable inductance has a magnetic circuit with a flux bearing region. A main winding and at least one control winding surrounds the portions of the flux bearing region. A control device is coupled to the control winding for varying the distribution of flux. The winding is formed of a magnetically permeable, field-confining insulating cable.

### CROSS-REFERENCE TO RELATED APPLICATIONS

This application is related to copending U.S. application Ser. No. [to be assigned], Attorney Docket No. 70722-2/430, and U.S. application Ser. No. [to be assigned], Attorney Docket No. 70754-2/8137, the teachings of which are incorporated herein by reference.

### TECHNICAL FIELD

The present invention relates to a controllable high power static electromagnetic device, and in particular to a controllable high power transformer, reactor, inductance, or regulator.

For all transmission and distribution of electric energy, various static inductive devices such as transformers, reactors, regulators and the like are used, and their task is to allow exchange or control of electric energy in and between two or more electric systems. A transformer is a classical electrical product which has existed, both theoretically and practically, for more than 100 years. Transformers are available in all power ranges from the VA up to the 1000 MVA range. With respect to the voltage range, there is a spectrum up to the highest transmission voltages which are being used today.

Transformers, reactors and regulators belong to an electrical product group of static inductive devices which are known and are relatively easy to understand. Energy transfer is achieved by electromagnetic induction. There are a great number of textbooks, patents and articles which describe the theory, operation, calculations, manufacture, use, service life, and the like, of such devices' components and subsystems such as windings, core, tank, accessories and cooling systems.

The invention relates to an inductive device of the so-called high power type with a rated power ranging from a few hundred kVA up to more than 1000 MVA with a rated voltage ranging from 3-4 kV and up to very high transmission voltages, 400 kV to 800 kV or higher.

While the inventive concept which forms the basis of the present invention is applicable to various inductive devices including reactors, the following description mainly relates to power transformers. As is known, the devices herein categorized may be designed as single-phase and three-phase systems. Also, air-insulated and oil-insulated, self-cooled, oil cooled, etc., devices are available. Although devices have one or more winding (per phase) and may be designed both with and without an iron core, the foregoing description of the background art is to a large extent relevant to devices with an iron core having a region of variable high reluctance.

The invention further relates more specifically to a controllable inductance wherein the magnetic flux is redistributed between different flux paths by affecting the reluctance of at least one of such paths. In a reactor the invention operates as a series or shunt element with variable inductance.

### BACKGROUND OF THE INVENTION

A comprehensive description of conventional transformers and reactors is described in the above-identified related Patent Applications and such description will not be repeated here except where thought necessary.

A comprehensive publication describing transformers in general, and more particularly, power transformers, is set forth in The J & P Transformer Book, A Practical Technology of the Power Transformer, by A. C. Franklin and D. P. Franklin, published by Butterworths, edition 11, 1990.

Known internal electrical insulation of windings was described in Transformerboard, Die Verwendung von Transformerboard in Grossleistungstransformatoren by H. P. Moser, published by H. Weidman A G, CH-8640 Rapperswil.

From a purely general point of view, the primary task of a power transformer is to allow exchange of electric energy between two or more electrical systems of, usually, different voltages with the same frequency.

A conventional power transformer of the core type shown in FIG. 8A comprises a core, often of laminated oriented sheet, usually of silicon steel. The core comprises a number of core limbs with legs, connected by yokes or arms which together form one or more core windows. Transformers with such a core are often referred to as core transformers. Around the core limbs there are a number of windings which are normally referred to as primary, secondary and tap windings. As far as power transformers are concerned, these windings are practically always concentrically arranged and distributed along the length of the core limbs. The core transformer usually has circular coils as well as a tapering core limb section in order to fill up the window as effectively as possible.

In addition to the core type transformer there is so-called shell-type transformer shown in FIG. 8B. These are often designed with rectangular coils and a rectangular core limb section. Reactors are of similar design but may not include a secondary.

Conventional induction controlled voltage regulators for lower voltage ranges are arranged by using inductors with coils rotated or shifted in relation to each other as described in the literature, e.g., by I. L. Ia Cour and K. Faye-Hansen in the book Die Wechselstromtechnik Bd. 2, “Die Transformatoren”, Verlag von Julius Springer, Berlin, Germany, 1936, pages 586-598, “Drehtransformator und Schubtransformator”. Also this solution involves mechanical movements. Furthermore, such an induction control cannot be made for high voltage at reasonable costs. The insulation construction results in a severe design limitation.

Another technique is known from U.S. Pat. No. 4,206,434 where the magnetic flux between different legs of an induction controlled voltage regulator is described to be redistributed by a variable DC magnetization. For this purpose a variable DC-source is needed.

Thus, electric high voltage control is mostly made by electric transformers involving one or more windings wound on one or more legs of the transformer iron core. The windings involve taps making possible of supplying different voltage levels from the transformer. Known power transformers and distribution transformers used in voltage trunk lines involve tap-changers for the voltage regulation. These are mechanically complicated and are subject to mechanical wear and electrophysical erosion due to discharges between contacts. Regulation is only possible in steps. Thus, a stepwise voltage regulation and movable contacts are required for connection with the different taps. It may be disadvantageous to include movable means for high voltage control and not to be able to obtain a step-free continuous voltage supply.

### SUMMARY OF THE INVENTION

The invention provides a high power static electromagnetic device with a rated power ranging from a few hundred kVA up to over 1000 MVA with a rated voltage ranging from 3-4 kV and up to very high transmission voltages, such as 400 kV to 800 kV or higher, and which does not entail the disadvantages, problems and limitations which are associated with the prior art power transformers/reactors. The invention is based on the realization that, individual control of the flux paths in the device enables broad control functions not hereinbefore available.

In a particular embodiment the invention comprises a transformer employing one or more windings including a main winding and a control winding in operative relation therewith. The control winding when suitably energized or loaded controls flux distribution within the device. At least one of the windings is formed of one or more current-carrying conductors surrounded by a magnetically permeable, electric field confining insulating cover.

In a particular exemplary embodiment, the cover comprises a solid insulation surrounded by an outer and an inner potential-equalizing layer being partially conductive or having semiconducting properties, within which inner layer the electric conductor is located. As a result the electric field is confined within the winding. The electric conductor, according to the invention, is arranged so that it has conducting contact with the inner semiconducting layer. As a result no harmful potential differences arise in the boundary layer between the innermost part of the solid insulation and the surrounding inner semiconductor along the length of the conductor.

The device according to an exemplary embodiment of the invention may be loaded with a variable impedance which in turn controls the flux path for the device. In a transformer, by varying the flux in one or more of the legs in the core, various voltage outputs may be achieved without the necessity for stepwise control. In a reactor, control of the flux in the core results in a variable reactor. In a regulator, voltage control is achieved.

In another exemplary embodiment of the invention, the flux may be amplitude, phase, or frequency modulated by active means such as a suitable signal source coupled to the control winding.

In a particular exemplary embodiment at least one winding may be loaded with a variable impedance in at least one magnetic flux path or leg of the magnetic circuit may have a region of reduced permeability (high reluctance), for example, an air gap. The flux in the leg can be varied by varying the impedance of the control winding. In the particular embodiment the impedance variation is achieved by means of a variable capacitor. As a result, the flux may be redistributed between different legs of the magnetic circuit, and the induced voltage in the windings surrounding the legs as well as the inductance of the device, is controllable. The principle may be used in many different geometrical arrangements, depending upon the device, the number of phases, or other features.

The specific theory behind the negative reluctance of a winding loaded with an impedance is mainly given by the following idealized equations. A winding loaded with an impedance forms a variable reluctance R_{c}=n²ω²Z. The number of winding turns n and the regulation of the impedance Z (R, L, 1/c) may be chosen in such a way to correspond to the reluctance R_{L}=L/A μ₁ μ₀, where L is the length of the flux path,

A is the cross section area of the magnetic core,

μ₁ is the permittivity of the flux path, and

μ₀ is the permittivity of air.

The distribution of the magnetic flux φ onto the different legs of the magnetic core, and hence the voltage of the windings wound on these legs, is variable as a function of the impedance.

Depending on the type of regulation used, the regulation is continuous or made in small steps, corresponding to discrete impedance switched into the circuit. Due to relationship between number of turns and reluctance, one can choose low turn number combined with low voltage, high current and large impedance or high turn number combined with high voltage, low current and low impedance, depending on which realization of the variable impedance being most practical. Using the cable described herein, the impedance may be integrated within the device housing, as its windings are potential free.

The invention is based in part on the realization that the semiconducting layers exhibit similar thermal properties as regards the coefficient of thermal expansion and the solid insulation. The semiconducting layers according to the invention may be integrated with the solid insulation to ensure that these layers and the adjoining insulation exhibit similar thermal properties to ensure good contact independently of the variations in temperature which arise in the line at different loads. At temperature gradients the insulating layer and semiconducting layers form a monolithic core for the conduction and defects caused by different temperature expansion in the insulation and the surrounding layers do not arise.

The electric load on the material is reduced as a consequence of the fact that the semiconducting parts around the insulation form equipotential surfaces and the electric field in the insulating part will hence be distributed nearly uniformly over the thickness of the insulation.

In particular, the outer semiconducting layer exhibits such electrical properties that potential equalization along the conductor is ensured. The semconducting layer does not, however, exhibit such conductivity properties that the induced current causes an unwanted thermal load. Further, the conductive properties of the layer are sufficient to ensure that an equipotential surface is obtained. Exemplary thereof, the resistivity, ρ, of the semiconducting layer generally exhibits a minimum value, ρmin=1 Ωcm, and a maximum value, ρmax=100 kΩcm, and, in addition, the resistance of the semiconducting layer per unit of length in the axial extent, R, of the cable generally exhibits a minimum value Rₘᵢₙ=50 Ω/m and a maximum value Rₘₐₓ=50 MΩ/m.

The inner semiconducting layer exhibits sufficient electrical conductivity in order for it to function in a potential-equalizing manner and hence equalizing with respect to the electric field outside the inner layer. In this connection the inner layer has such properties that it equalizes any irregularities in the surface of the conductor and that it forms an equipotential surface with a high surface finish at the boundary layer with the solid insulation. The layer may, as such, be formed with a varying thickness but to ensure an even surface with respect to the conductor and the solid insulation, its thickness is generally between 0.5 and 1 mm. However, the layer does not exhibit such a great conductivity that it contributes to induce voltages. Exemplary thereof, for the inner semiconducting layer, thus, Pmin=10⁻⁶ Ωcm, Rₘᵢₙ=50 μΩ/m and, in a corresponding way, Pmax=100 kΩcm, Rₘₐₓ=5 MΩ/m.

In an exemplary embodiment, a transformer according to the invention operates as a series element with variable leakage inductance and thus reactance. Such a transformer is capable of controlling power flow by redistribution of active or reactive effects between networks connected to the primary and secondary. Such a transformer is capable of limiting short circuit occurrence, and provides for good transient stability. The transformer is also capable of damping power oscillations and providing good voltage stability. Such arrangements are extremely useful for planners and operators of transmission networks, in particular in countries with a deregulated electricity market. The deregulation usually involves a separation of power production and transmission services into separate entities. Thus, the previously existing link between the planning of generation plants and transmission of power no longer exists. Thus, the plant operator may announce the closing of a generation plant at time scales which are, from a hardware point of view, short and thus present operators and planners of transmission with major problems associated with power flow patterns which may influence the dynamic behavior of the system. The present invention, therefore, allows for a flexible AC transmission system with control of the components wherein the power flow can be controlled. In the particular embodiment, the ability to control power flow is implemented in a component which is normally needed for other purposes. Thus, the invention allows for dual use without significant increase in cost.

In accordance with another embodiment of the invention, a reactor is operable either as a series or shunt element with variable inductance and thus reactance. There is no need for power electronics in the main power circuit. Accordingly, losses are lower. Further, the control equipment is generally low voltage equipment and thus, simpler and more economical. The arrangement also avoids the problem of harmonics generation. As a shunt element, the variable reactor can perform fast variable reactive power compensation. As a series element, the variable reactor according to the invention is capable of performing power flow control by redistribution of active or reactive effect between lines. The reactor can limit short circuit currents, can provide transient stability, damp power oscillations and provide voltage stability. These features are likewise important for flexible AC transmission systems.

The drawbacks of prior art voltage regulation are avoided by an induction controlled voltage regulator according to the invention, wherein the magnetic circuit of the regulator includes at least one magnetizable regulation leg with a zone of reduced permeability, and by at least one further winding wound around said regulation leg, said further winding being connected to a variable impedance or arc control element. By placing at least one winding loaded with a variable capacity on at least one magnetic flux path or leg having a zone with reduced permeability across the magnetic flux, the reluctance of the leg can be varied by varying the capacitance. This redistributes the magnetic flux between different legs of the magnetic circuit and the induced voltage across windings surrounding these legs as well as the inductance of the windings is changed.

### BRIEF DESCRIPTION OF THE DRAWINGS

The invention will now be described with reference to the accompanying drawings, wherein

FIG. 1 shows the electric field distribution around a winding of a conventional inductive device such as a power transformer or reactor;

FIG. 2 shows an embodiment of a winding in the form of a cable in a high power inductive device according to the invention;

FIG. 3 shows an embodiment of a power transformer according to the invention;

FIG. 4A is a schematic illustration of a controlled transformer in accordance with the present invention;

FIG. 4B is a schematic illustration of a reactor in accordance with the present invention;

FIG. 5 is a schematic illustration of a controlled reactor in accordance with the present invention;

FIGS. 6A-6C are illustrations of a voltage regulator according to an alternative embodiment of the invention;

FIG. 7 is a schematic illustration of a three-phase transformer having various flux paths according to the invention; and

FIGS. 8A and 8B illustrate known shell and core type transformers.

### DESCRIPTION OF THE PREFERRED EMBODIMENTS

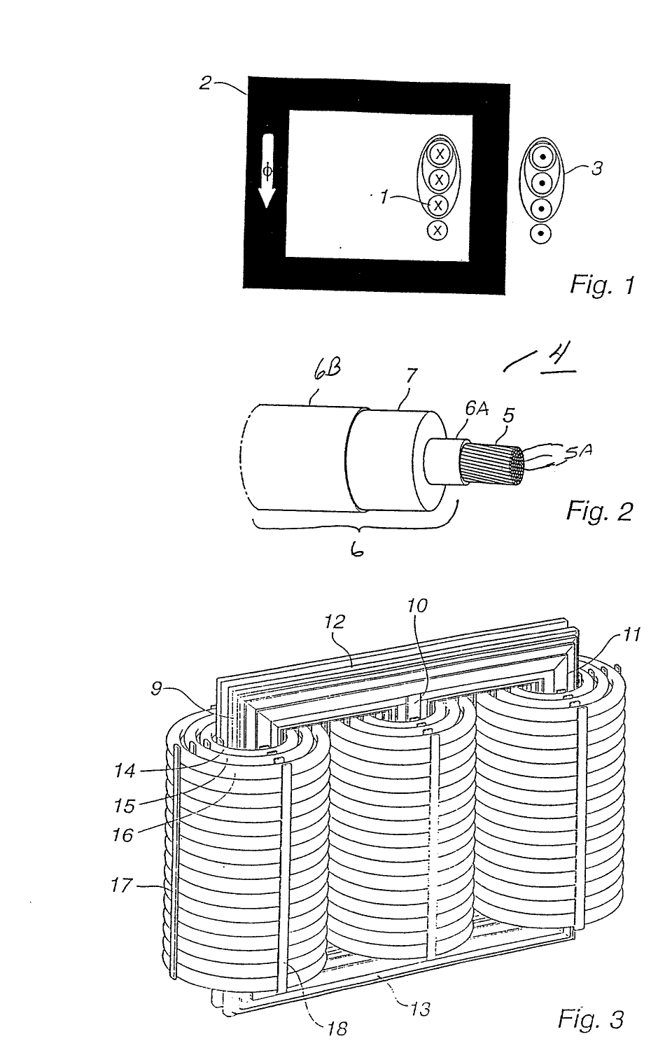

FIG. 1 shows a simplified and fundamental view of the electric field distribution around a winding of a conventional power transformer/reactor, where 1 is a winding and 2 a core and 3 illustrates equipotential lines, i.e., lines where the electric field has the same magnitude. The lower part of the winding is assumed to be at earth potential.

The potential distribution determines the composition of the insulation system since it is necessary to have sufficient insulation both between adjacent turns of the winding and between each turn and earth. FIG. 1 shows that the upper part of the winding is subjected to the highest dielectric stress. The design and location of a winding relative to the core are in this way determined substantially by the electric field distribution in the core window.

FIG. 2 shows an example of an exemplary cable which may be used in the windings which are included in high power inductive devices according to the invention. Such a cable 4 comprises at least one conductor 5 including a number of strands 5A with a core 6 surrounding the conductor. The core includes an inner semiconducting layer 6A disposed around the strands. Outside of this inner semiconducting layer is the main insulation layer 7 of the cable in the form of a solid insulation, and surrounding this solid insulation is an outer semiconducting layer 6B. The cable may be provided with other additional layers for special purposes, for example for preventing too high electric stresses on other regions of the transformer/reactor. From the point of view of geometrical dimension, the cables in question will generally have a conductor area which is between about 30 and 3000 mm² and an outer cable diameter which is between about 20 and 250 mm.

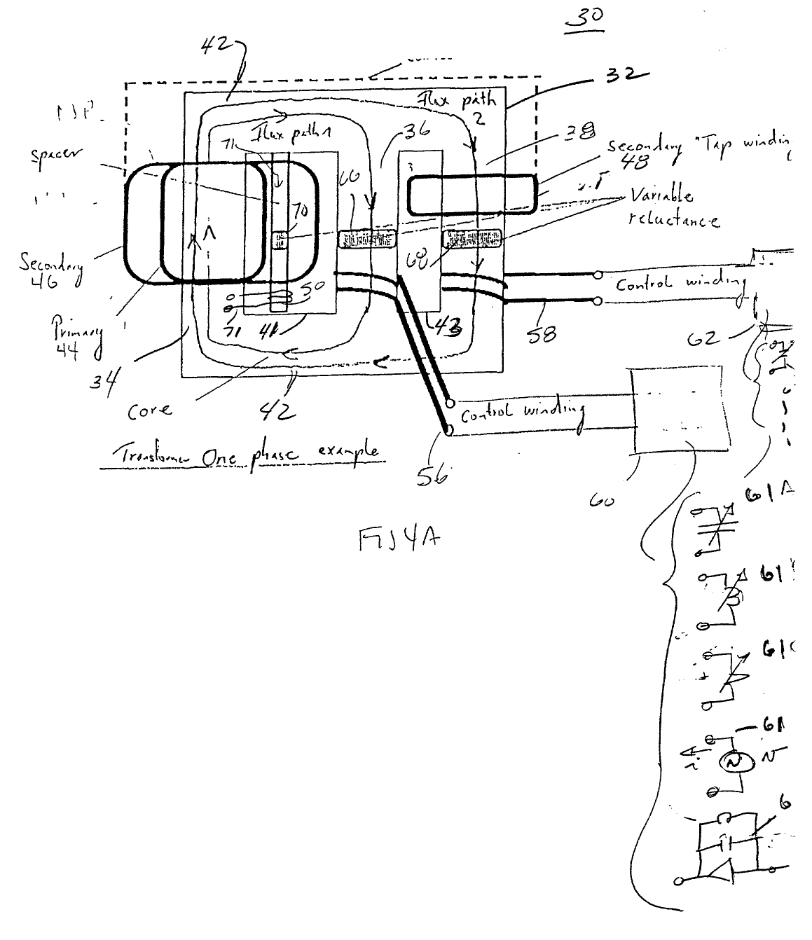

The windings manufactured from the cable 4 described herein may be used both for single-phase, three-phase and polyphase devices independently of how the core is shaped. The embodiment in FIG. 3, shows a three-phase laminated core transformer. The core comprises, in conventional manner, three core limbs 9, 10 and 11 and the retaining yokes or arms 12 and 13. In the embodiment shown, both the core limbs and the yokes have a tapering cross section.

The windings formed with the cable 4 are located concentrically around the core limbs. As is clear, the embodiment shown in FIG. 3 has three concentric winding turns 14, 15 and 16. The innermost winding turn 14 may represent the primary winding and the other two winding turns 15 and 16 may represent secondary windings. In order not to overload the figure with too many details, the connections of the windings are not shown. Otherwise the figure shows that, in the embodiment shown, spacing bars 17 and 18, which among other things provide structural stability for the windings, are located at certain points around the windings. The spacing bars may be formed of magnetically permeable material or insulating material and are intended to provide a certain space between the concentric winding turns for cooling support. They may also be formed of electrically conducting material in order to form part of the earthing and magnetic system of the windings.

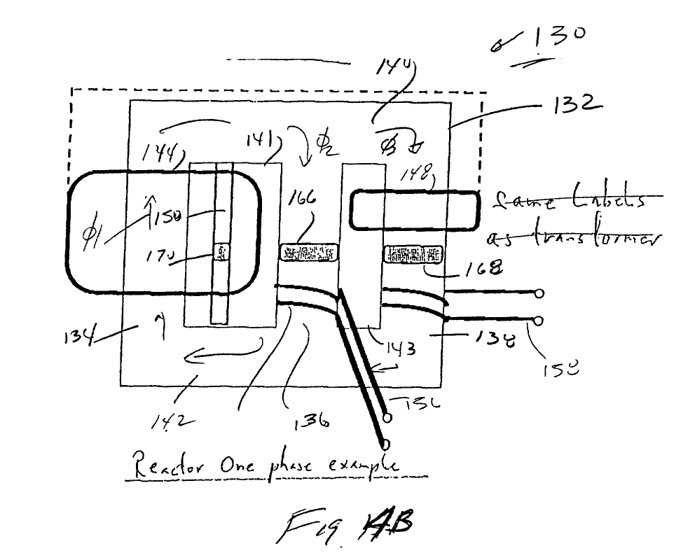

FIG. 4A shows a high power inductive device in the form of a single phase core type transformer 30 in accordance with the present invention. The transformer 30 comprises a core 32 which is formed with legs 34,36 and 38 and upper and lower arms 40 and 42. The core 32 may be made of laminated sheets having apertures or windows 41 and 43. Alternatively, the transformer 30 may be a shell type or an air wound type.

In order to form a core type transformer, a primary winding 44 is wrapped around the leg 34. In a similar manner, a secondary winding 46 may be wrapped concentrically with the primary winding 44 about the leg 34 or on another leg. If desired, a secondary tap winding 48 in series with the primary winding 44 may be wrapped around the leg 38.

A spacer 50 may be provided in the window 41 between the upper and lower arms 40 and 42. The spacer 50 may be a soft iron bar or may be formed integrally with the laminated sheet for providing support for the core and also for providing a flux path hereinafter discussed.

A first control winding 56 may be wrapped around the leg 36 as shown and a second control winding 58 may be wrapped around the leg 38 as illustrated. A first control means 60 may be coupled to the first control winding 56 and a second control means 62 may be coupled to the control winding 58 as illustrated. The control means may include active and passive elements, for example, one or more of a fixed or variable capacitor, inductor, resistor, current or voltage source or active filter 61A-61E. Likewise, the control 62 may include one or more of such elements 62A-E.

In accordance with the invention, the legs 36 and 38 and the spacer 50 may optionally have a region in the form of a gap of high reluctance 66, 68 and 70. This region may be an air gap or a nonmagnetic spacer. The gap is sufficient to allow control of the flux with good dynamic range and may vary in size generally from a few millimeters to 100 mm. The control windings 56 and 58 are adapted to produce variations in flux distribution through the legs. Likewise, a control winding 71 may be employed to control the flux distribution in the spacer 70.

In a conventional transformer, the primary winding produces a corresponding flux φ in the core. In a simple transformer having only two legs, the flux completes a magnetic circuit in one continuous loop or a loop with a gap. In the arrangement illustrated in FIG. 4A, the flux φ is divided and follows respectively as φ2 and φ3 in the corresponding legs 36 and 38 as shown.

In the arrangement illustrated in FIG. 4A, the primary transformer has N1 turns, the secondary has N2 turns, and the tap has N3. In a simple transformer, the voltage V1 in the primary divided by the number of turns N1 therein equals the voltage V2 in the secondary divided by the number of turns N2 therein. Thus, the voltage ratio V1/V2 equals the turns ratio N1/N2 in a well known relationship. In the arrangement of FIG. 4A, the foregoing relationship is true if the flux φ3 in leg 38 is 0. However, if one assumes that φ3 is at a maximum, then the number of turns N3 in the secondary tap winding 48 is added to the turns N1 in the primary (because they are in series), and the relationship above is modified so that V1/V2=(N1+N3)/N2, thereby increasing the voltage at the output. According to the invention, the flux distribution in the corresponding legs 36 and 38 of the core 32 may be thus varied so as to vary the voltage relationship between the primary and the secondary.

While it is possible to provide an air gap at 66 and 68 and vary the air gap mechanically, this is not an economic solution. Accordingly, the control windings 56 and 58 are provided. If the control winding 58 is loaded with a variable capacitive reactance, for example, 62A as shown, it is possible to vary the capacitance so as to block or close the flux path φ3 so that the voltage relationship between the primary and the secondary is simply that of the turns ratio N1/N2. Alternatively, the capacitance may be selectively varied so that the flux φ3 is unimpeded or partially impeded. If, on the other hand, the control winding 56 is loaded with a variable capacitive reactance 61A, the flux path φ2 may likewise be completely blocked and the voltage relationship between the primary and the secondary is in accordance with the turns ratio of the primary plus the tap divided by the secondary (N1+N3)/N2. The degree of capacitive loading will determine the final value of the voltage ratio.

Thus, a variable transformer has been provided in which a control winding which varies the flux path in each leg to affect transformer output. It should be understood that variable impedances of alternative kinds may be used. For example, if a variable inductor is used, the reluctance varies inversely to the inductance. Thus, high inductive loading will result in a corresponding high flux distribution in the leg. If a high resistance is used as a load for the control winding, a high flux distribution results in the leg. If the control winding is shorted, the effect is similar to a conductive ring located about the core leg in that the flux will be blocked. Various combinations of fixed and variable real and reactive loading may also be provided. In addition, loading or activation may be provided by an active element, for example, an active filter. Such a filter could be programmable.

It is also possible to provide a variable power source, e.g., a voltage or current source 61D for the control winding 56 to produce an input thereon which is adapted to modulate the flux φ2 in the leg 36. Modulation may be in terms of amplitude, phase and frequency. A similar arrangement may be employed for the control winding 58. It is also possible to provide an active filter such as 61E as an element in the control 61 to thereby vary the performance of the control winding and thus modulate the transformer output.

As noted above, the spacer 50 is provided for dimensional stability and support, and to provide a flux bearing path in order to guide the flux in the transformer in the event of a fault in the primary or secondary. In the event of a fault, a compensating air gap or reluctance 70 through the spacer 50 provides a flux path for increasing the impedance of the transformer to a safe level to thereby avoid a catastrophic failure. The flux through this compensating reluctance 70 may be varied, if desired, by the control circuits herein described. Likewise, one or more of the spacers 17 shown in FIG. 3 may be used as alternative flux paths which may be controlled. Such an arrangement provides an added degree of freedom not hereinbefore available in high power transformers.

In accordance with the present invention, a high power transformer is provided utilizing the high voltage cable 4 illustrated in FIG. 2. Such a cable allows a very high power operation without field control or partial discharge. Thus, the present invention is capable of operating as a variable transformer and a high power transformer in a manner not heretofore possible.

FIG. 4B illustrates a high power reactor 130 in accordance with the present invention. The arrangement of the reactor 130 is similar to that of the transformer 30 in FIG. 4A, except that no secondary is provided. Thus, for convenience similar elements in the reactor 130 will have reference numerals in a 100 series. In the arrangement illustrated, the primary winding 144 is in series with the secondary tap winding 148. Thus, the reactor 130 comprises a pair of inductors in series.

By varying the flux distribution in the core 132, the inductance of the circuit may be likewise changed. For example, maximum inductance occurs when the flux path φ2 in the leg 136 This can be achieved by a high capacitive load or a short circuit across the control winding 156. Likewise, the inductance of the circuit is minimized when the flux in path φ3 is reduced by an increase in the variable reluctance 168.

The reactor illustrated in FIG. 4B may likewise be manufactured with a cable 4 arrangement as illustrated in FIG. 2, so as to provide for high power performance.

The arrangements in FIGS. 4A and 4B are one phase systems. It should be understood that a three phase device may likewise be employed in the same manner in order to enjoy the benefits of three phase operation.

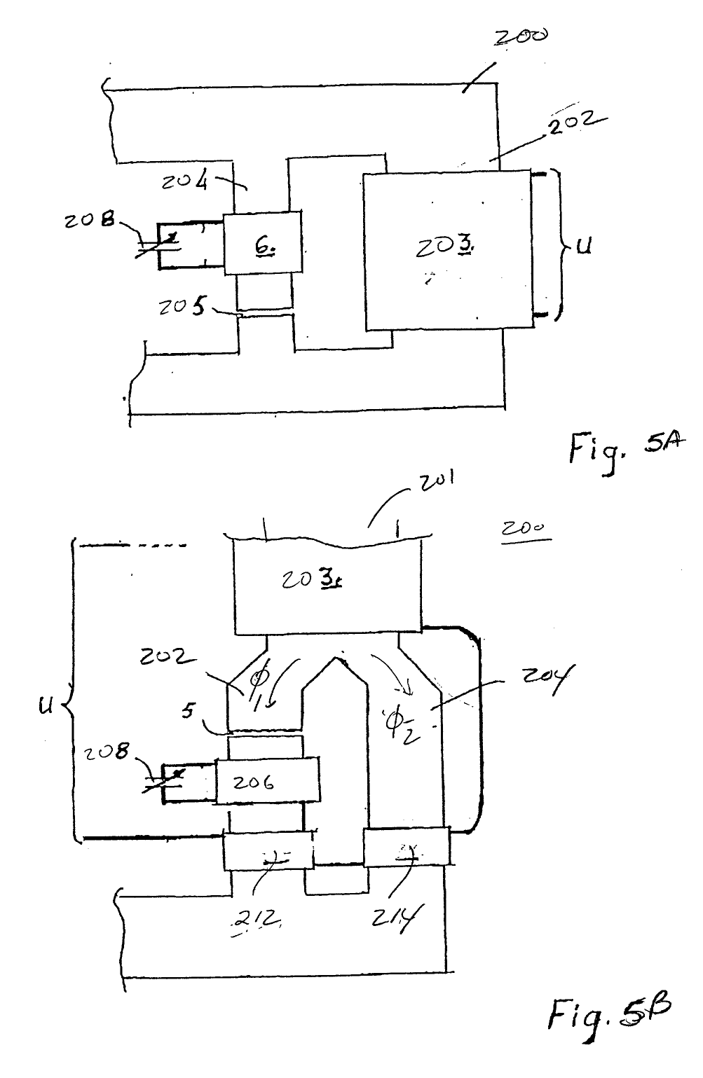

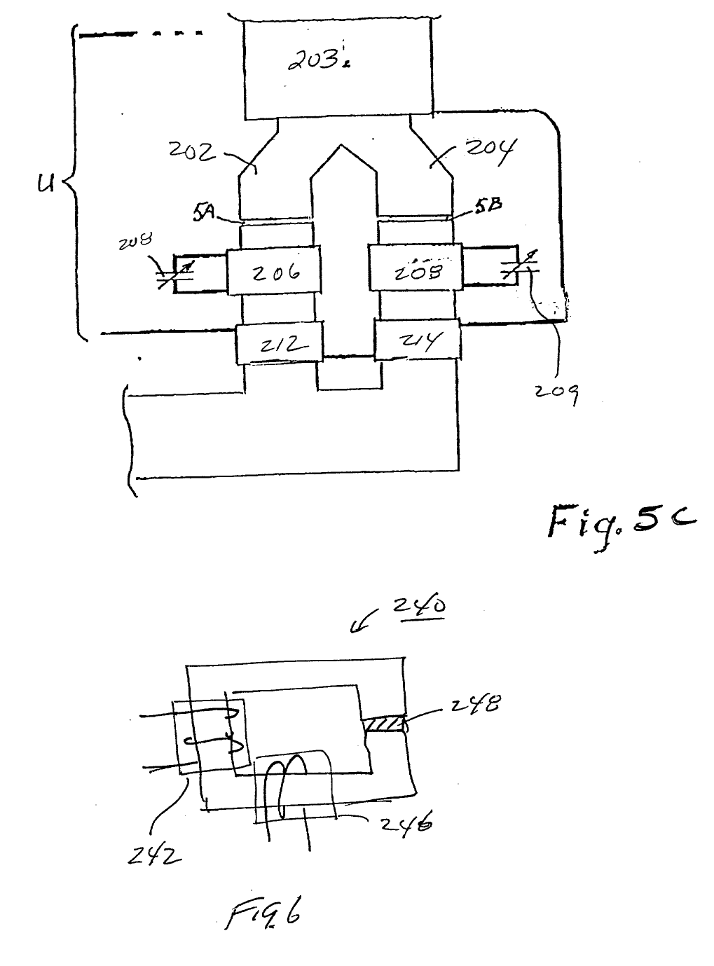

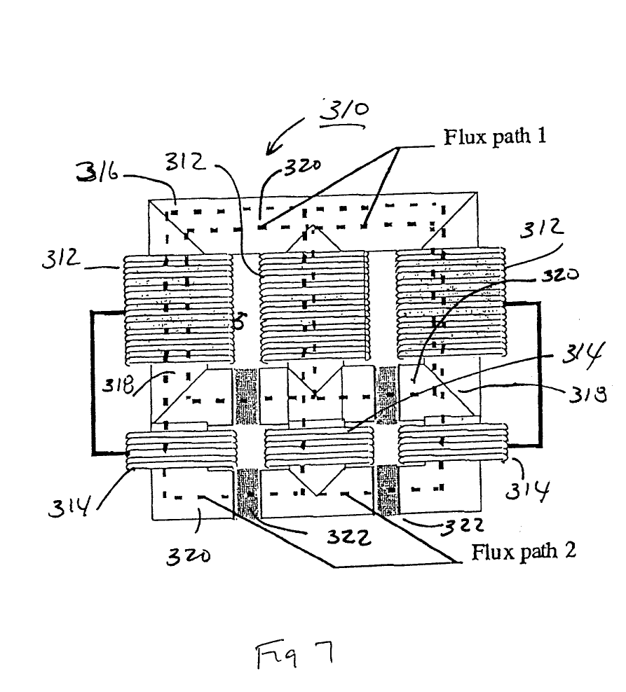

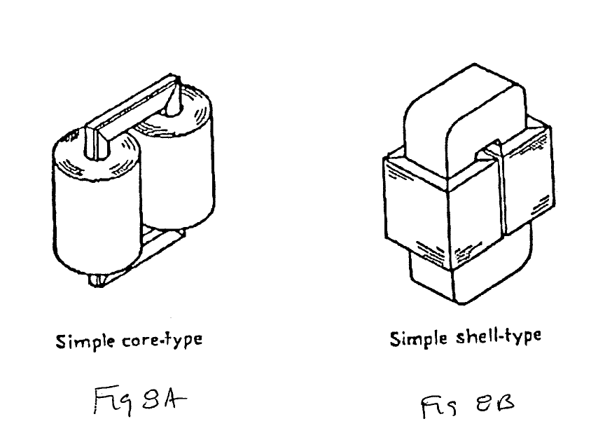

In accordance with another embodiment of the invention, a part of a transformer or reactive core 200 is shown in FIG. 5A. The core 200 has a main flux leg 202 and a magnetic circuit including two or more flux paths or legs 202 and 204. One of the legs 202 is shown in FIG. 5A, having a main winding 203. In parallel with the leg 202, there is shown a magnetizable regulator or control leg 204 with a zone 205 of reduced permeability. The zone 205 may be an air gap, multiple gaps, cavities in the core, or solid material inserts having a permeability μ1 being lower than that of the core material or may be obtained by other suitable means.

The regulator leg 204 is surrounded by an additional winding 206 which is connected to a variable capacitor 208. According to the invention, a negative reluctance is produced by a winding loaded with a capacitance. As a result, the output V1 of the main winding 203 can be controlled or regulated by changing the capacitance of the capacitor 208.

Another embodiment of the invention is shown in FIG. 5B, wherein the main leg 201 carries the main winding 203 and is split into two sub-legs 202 and 204 downstream thereof. One of the sub-legs 202 corresponds to the control regulator leg 204 described above and includes a zone 205 with reduced permeability and a control winding coupled to a variable capacitor 208.

The output voltage from the main winding 203 may be supplied through two sub-windings 212 and 214 connected in series to the main winding 203. The sub-windings 212 and 214 are carried by a respective one of the sub-legs 202 and 204. The sub-windings 212 and 214 are wound opposing each other. Thus, the sub-windings may operate in such a way that, when the flux in one is rising the flux in the other is falling. Voltages in the sub-windings 212 and 214 will thus receive the same voltage with respect to the main winding 203. As a result, the voltage regulation or control range is doubled.

FIG. 5C illustrates a modified embodiment of the arrangement of 5B, wherein the sub-legs 212 and 214 include zones 222 and 224 of reduced permeability. The control windings 206 and 210 are connected to a separate variable capacitor 208 and 209 respectively. By having two control legs it is possible to increase the regulation range.

It is possible to apply the invention to a single phase induction coil 240 having a main winding 242 and a control winding 244 on a core 246 and with an optional air gap or conductive region 248. The flux φ in the core 246 may be varied by applying a load or control signal to the control winding as discussed hereinabove. It is also possible to employ such an arrangement to a multiphase reactor, voltage regulators, on-load-tap-changers such as a multiphase induction control voltage regulator, auto transformers and booster transformers, or in any application where a variable high voltage inductance is desirable.

FIG. 7 illustrates yet another embodiment of the invention wherein a three phase transformer 310 having main windings 312 and tap windings 314 wrapped on a core 316 is illustrated. The various flux paths are shown in dotted line in the legs 318 and the yokes 320. According to the invention, a control winding may be employed in each leg 318 or in each yoke 320. Air gaps or high conductivity regions 322 may be employed as hereinabove described. Also, spacers, as hereinabove described may be employed in the arrangement of FIG. 7. Such spacers may be likewise provided with air gaps or regions of high conductivity, and flux through such spacers may be controlled by an impedance or actively controlled winding. The windings may be in series or shunt as may be the flux bearing paths.

While there have been provided what are considered to be exemplary embodiments of the invention, it will be apparent to those skilled in the art that various changes and modifications therein may be made without departing from the invention, and it is intended in the appended claims to cover such changes and modifications as fall within the true spirit and scope of the invention.

I claim:

1. A static high power electromagnetic device comprising:
at least one main winding for producing a flux when energized comprising at least one current-carrying conductor and a magnetically permeable, electric field confining, insulating covering surrounding the conductor;
at least one control winding in operative relationship with the main winding;
a flux bearing region; and
control means coupled to the control winding for varying the flux in the flux bearing region.

2. A device according to claim 1, wherein the covering comprises at least one solid insulating layer surrounding the conductor and at least one partially conductive layer surrounding the conductor.

3. The device according to claim 1, further wherein the flux bearing region is magnetizable and is in operative relationship with the main winding and the control winding.

4. A device according to claim 1, wherein the magnetizable flux bearing region in operative relationship with the main winding and the control winding includes at least one of a shell and core.

5. A device according to claim 1, further including a region of relatively high reluctance in the flux bearing region in operative relationship with at least one of the main winding and the control winding.

6. A device according to claim 1, wherein the main winding and the control winding are in at least one of a shunt and series relationship.

7. A device according to claim 1, including a magnetic circuit having at least one of serial and parallel paths and wherein the control winding is located in at least one of said serial and parallel paths.

8. The device according to claim 1, wherein the control means comprises at least one of active and passive impedances.

9. The device of claim 8, wherein the impedances comprise a reactive impedance.

10. The device according to claim 8, wherein the impedance comprises a real impedance including at least one of an open circuit, a short circuit, and a resistance in operative relationship with the control winding.

11. The device according to claim 1, wherein the winding comprises a flexible cable.

12. A device according to claim 1, wherein the cover comprises an inner layer surrounding the conductor having semiconducting properties; a solid insulating layer surrounding the inner layer; and an outer layer having semiconducting properties surrounding the insulating layer.

13. A device according to claim 12, wherein the inner layer is in electrical contact with the conductor and is operative at the same potential thereof.

14. A device according to claim 12, wherein the outer layer comprises an equipotential surface surrounding the insulating layer.

15. A device according to claim 12, wherein the outer layer is connectable to at least one selectable potential.

16. A device according to claim 15, wherein the selected potential is ground.

17. The device according to claim 12, wherein at least one of said semiconducting layers has substantially the same coefficient of thermal expansion as the insulating layer.

18. A device according to claim 12, wherein the cover is substantially void free.

19. A device according to claim 12, wherein each semiconducting layer has a contact surface in confronting relationship with the corresponding surfaces of the insulating layer and wherein said contacting surfaces are joined therealong.

20. A device according to claim 12, wherein the first layer and the second layer are formed of polymeric materials.

21. A device according to claim 1, wherein the winding comprises a transmission line.

22. A device according to claim 1, wherein the cable is manufactured with a conductor area which is between about 30 and 300 mm² and with an outer cable diameter which is between about 20 and 250 mm.

23. A device according to claim 1, wherein the solid insulation is formed of a polymeric material.

24. A device according to claim 1, wherein the solid insulation comprises an extrusion.

25. A device according to claim 2, wherein the current-carrying conductor comprises a first number of strands being insulated from each and a second number of uninsulated strands in order to secure electric contact with the semiconducting layer.

26. A device according to claim 2, wherein at least one of the strands of the conductor is uninsulated and arranged in such a way that electrical contact is achieved with the semiconducting layer.

27. A device according to claim 1, comprising at least two galvanically separated concentrically wound windings.

28. A device according to claim 1, comprising at least one of a power transformer and reactor connected to at least two voltage levels.

29. A device according to claim 1, wherein the winding includes power cable terminations.

30. A device according to claim 1, wherein the winding thereof is designed for a voltage suitably in excess of at least one of 10 kV, 36 kV, 72.5 kV 400 kV, and at least 800 kV.

31. A device according to claim 1, wherein the winding thereof is designed for a power range in excess of at least 0.5 MVA, and at least 30 MVA.

32. A device according to claim 1, further including cooling means comprising at least one of liquid and gas on earth potential.

33. A method for the production of a device according to claim 1, comprising the step of threading the cable on-site.

34. A device according to claim 1, including a zone of reduced permeability comprising at least one of an air gap and a conductive element and solid inserts of a material with low permeability.

35. A device according to claim 34, wherein said zone of reduced permeability comprises cavities formed in said conductive element.

36. A device according to claim 1, including a core comprising a main leg split into two sub-legs, at least one of the sub-legs forming a control leg for the control winding.

37. A device according to claim 1, including a core comprising a main leg split into two sub-legs, each one forming a control leg for each control winding.

38. A device according to claim 37, wherein said main winding is formed by two sub-windings connected in series to each other, each sub-winding being wound around a sub-leg belonging thereto.

39. A device according to claim 1, wherein said device comprises a multiphase transformer having a control leg in each phase for independent regulation of each phase.

40. A device according to claim 1, wherein said device comprises a multiphase transformer having a control leg in each phase, where the said control windings of the control legs are connected for having a joint regulation.

41. A device according to claim 1, wherein said device comprises at least one of an autotransformer and a booster transformer.

42. A high power variable inductance device comprising:
a magnetic circuit including a flux path and a flux bearing region;
a main winding surrounding the flux path;
at least one control winding surrounding the flux path; and
control means coupled to the control winding operable when energized, for selectively varying the flux in the flux bearing region.

43. The device of claim 42, wherein the flux bearing region comprises at least one spacer for stabilizing at least one winding.

44. The device of claim 43, wherein the spacer has a region of reduced permeability.

45. The device of claim 42, wherein the control means includes an impedance.

46. The device of claim 45, wherein the impedance comprises at least one of a reactive and real impedance.

47. The device of claim 46, wherein the reactive impedance includes at least one of a capacitive and inductive load.

48. The device of claim 46, wherein the impedance is variable.

49. The device of claim 42, wherein the control includes at least one of an active and passive filter.

50. The device of claim 42, wherein the control includes a power source including means for varying at least one of the amplitude, frequency and phase of the flux in the flux bearing region.

51. A high power variable inductance device comprising:
a magnetic circuit including a flux path and a flux bearing region within the flux path having selectively variable flux bearing properties;
at least one main winding in operative relation with the flux path;
at least one control winding surrounding the flux path; and
control means coupled to the control winding operable when energized, for selectively varying the flux bearing properties in the region.

52. The device according to claim 51, wherein at least one of the windings comprises a current-carrying conductor and a magnetically permeable field-confining insulating cover.

53. The device of claim 51, wherein the flux bearing region comprises spacer means for supporting the winding and wherein the control winding is in operative relation with the spacer means.

54. The device according to claim 51, wherein the control means comprises a power source for producing at least one of amplitude, phase and frequency modulation for the control winding.
